(19) United States
(12) Patent Application Publication
(10) Pub. No.: US 2018/0322687 A1
(43) Pub. Date: Nov. 8, 2018

(54) APPARATUS AND METHOD FOR PROVIDING INTERACTIVE CONTENT

(71) Applicant: ELECTRONICS AND TELECOMMUNICATIONS RESEARCH INSTITUTE, Daejeon (KR)

(72) Inventors: Hang-Kee KIM, Daejeon (KR); Ki-Suk LEE, Daejeon (KR); Ki-Hong KIM, Sejong-si (KR)

(21) Appl. No.: 15/895,869

(22) Filed: Feb. 13, 2018

(30) Foreign Application Priority Data
May 2, 2017 (KR) 10-2017-0056543

(51) Int. Cl. G06T 15/20; G06F 3/01; G06T 7/536; G06T 19/00

(52) U.S. Cl. CPC G06T 15/20; G06T 19/003; G06T 7/536; G06F 3/011

(57) ABSTRACT

Disclosed herein are an apparatus and method for providing interactive content. The apparatus for providing interactive content includes an object classification unit for classifying content to be output into a view-independent background and view-dependent objects, a viewpoint association unit for determining viewpoints of users who are to be interactively associated with respective view-dependent objects and interactively associating the viewpoints of the users with the view-dependent objects, a rendering unit for generating a background-visualized image by rendering the view-independent background with respect to a hot spot, and generating object-visualized images by rendering the view-dependent objects based on the viewpoints interactively associated with respective view-dependent objects, and an output unit for outputting the background-visualized image and the object-visualized images.

### CROSS REFERENCE TO RELATED APPLICATION

This application claims the benefit of Korean Patent Application No. 10-2017-0056543, filed May 2, 2017, which is hereby incorporated by reference in its entirety into this application.

### BACKGROUND OF THE INVENTION

### 1. Technical Field

The present invention relates generally to an apparatus and method for providing interactive content, which separately visualize a view-independent background and view-dependent objects for interactive image experience content technology simultaneously enjoyed by multiple persons.

### 2. Description of the Related Art

Generally, when screen visualization methods are considered from the viewpoint (view) of a user, they may be classified into a view-independent method for displaying images without regard to the viewpoint of the user and a view-dependent method for displaying images in accordance with the viewpoint of the user (the location and direction of a head or an eye).

The method for displaying images without regard to the viewpoint of the user is a display method that is used in places such as a theater or a dome, or that is used for wallpapering, and is utilized when multiple users simultaneously view the same image. In this case, when viewed from the individual viewpoint of each user, slight distortion appears in displayed images. However, since this method is characterized in that the size of a screen is large, the screen is viewed at a relatively long distance, and image distortion does not greatly influence a content experience, the advantage of allowing many persons to simultaneously view images together more than makes up for problems attributable to distortion.

However, when the size of the screen is small, as in the case of caves, the screen is viewed at a relatively short distance, and image distortion greatly influences a content experience, images may be unnaturally viewed, and users are prevented from being immersed in the images if the viewpoint of the images is not correctly set. Therefore, in order to solve this problem, image rendering based on the viewpoint is performed. In this case, an image may be viewed normally from the viewpoint of one user, but may be perceived as a distorted image when viewed from the viewpoints of other users. Accordingly, this method is mostly used in an individual immersive experience system for one person, rather than in a system that is simultaneously viewed by multiple persons. In particular, in a special effect or object created in relation to the body of a user, such as a ray effect of emitting light rays from the user's hand, the unnaturalness of an image may be reduced only when the image is represented by a view-dependent image corresponding to the viewpoint and posture of the corresponding user.

The above-described background technology is technological information that was possessed by the present applicant to devise the present invention or that was acquired by the present applicant during the procedure for devising the present invention, and thus such information cannot be construed to be known technology that was open to the public before the filing of the present invention. Korean Patent Application Publication No. 10-2015-0053730 discloses a technology related to “Method and system for image processing in video conferencing for gaze correction.”

### SUMMARY OF THE INVENTION

Accordingly, the present invention has been made keeping in mind the above problems occurring in the prior art, and an object of the present invention is to provide an apparatus and method for providing interactive content, which represent individual experience elements of each of multiple users based on the viewpoint of the corresponding user while allowing the users to simultaneously view an image via a single screen, by separately visualizing a view-independent background and view-dependent objects.

Another object of the present invention is to provide an apparatus and method for providing interactive content, which represent background objects, included in a view-independent background, and view-dependent interactive objects for interaction by adjusting the sizes of the background objects and the view-dependent interactive objects in consideration of depth information.

A further object of the present invention is to improve a feeling of satisfaction in an experience in immersive multi-user interactive images by maximizing personal experience elements through view-dependent interaction with a user.

In accordance with an aspect of the present invention to accomplish the above objects, there is provided an apparatus for providing interactive content, including an object classification unit for classifying content to be output into a view-independent background and view-dependent objects; a viewpoint association unit for determining viewpoints of users who are to be interactively associated with respective view-dependent objects, and interactively associating the viewpoints of the users with the view-dependent objects; a rendering unit for generating a background-visualized image by rendering the view-independent background with respect to a hot spot, and generating object-visualized images by rendering the view-dependent objects based on viewpoints interactively associated with respective view-dependent objects; and an output unit for outputting the background-visualized image and the object-visualized images.

The apparatus may further include an interaction calculation unit for calculating whether interaction between background objects, included in the view-independent background, and the view-dependent objects has occurred, and calculating an effect of the interaction using bounding volumes corresponding to collision ranges of the background objects, wherein the rendering unit generates the background-visualized image and the object-visualized images by reflecting the effect of the interaction based on the calculation by the interaction calculation unit.

The rendering unit may be configured to, when the background-visualized image is generated, determine hiding of the background objects and sizes of the background objects using a depth map corresponding to the view-independent background, and the bounding volumes may be determined in accordance with the sizes of the corresponding background objects.

The rendering unit may be configured to, when the object-visualized image is generated, determine sizes and locations of the view-dependent objects in consideration of the view-independent background and traveling directions based on the viewpoints interactively associated with respective view-dependent objects.

The rendering unit may be configured to determine changes in sizes of view-dependent interactive objects for interaction with the background objects depending on traveling of the view-dependent interactive objects in consideration of depths of the background objects in the depth map, corresponding to traveling directions of the view-dependent interactive objects.

The output unit may be configured to output the object-visualized images such that the object-visualized images are overlaid on the background-visualized image.

The interaction calculation unit may calculate the effect of the interaction using one or more of types of the view-dependent interactive objects, effects assigned to the view-dependent interactive objects, states of the background objects, and a location of a collision with each bounding volume.

The viewpoints are determined depending on locations and directions of pupils, heads, faces or eyes corresponding to the users.

The rendering unit may be configured to, when the object-visualized images are generated, perform stereoscopic rendering using a binocular disparity.

In accordance with another aspect of the present invention to accomplish the above objects, there is provided a method for providing interactive content, including classifying content to be output into a view-independent background and view-dependent objects; determining viewpoints of users who are to be interactively associated with respective view-dependent objects and interactively associating the viewpoints of the users with the view-dependent objects; generating a background-visualized image by rendering the view-independent background with respect to a hot spot, and generating object-visualized images by rendering the view-dependent objects based on the viewpoints interactively associated with respective view-dependent objects; and outputting the background-visualized image and the object-visualized images.

The method may further include calculating whether interaction between background objects, included in the view-independent background, and the view-dependent objects has occurred, and calculating an effect of the interaction using bounding volumes corresponding to collision ranges of the background objects, wherein generating the background-visualized image and the object-visualized images is configured to generate the background-visualized image and the object-visualized images by reflecting the effect of the interaction based on the calculation by the interaction calculation unit.

Generating the background-visualized image and the object-visualized images may be configured to, when the background-visualized image is generated, determine hiding of the background objects and sizes of the background objects using a depth map corresponding to the view-independent background, and the bounding volumes may be determined in accordance with the sizes of the corresponding background objects.

Generating the background-visualized image and the object-visualized images may be configured to, when the object-visualized image is generated, determine sizes and locations of the view-dependent objects in consideration of the view-independent background and traveling directions based on the viewpoints interactively associated with respective view-dependent objects.

Generating the background-visualized image and the object-visualized images may be configured to determine changes in sizes of view-dependent interactive objects for interaction with the background objects depending on traveling of the view-dependent interactive objects in consideration of depths of the background objects in the depth map, corresponding to traveling directions of the view-dependent interactive objects.

Outputting the background-visualized image and the object-visualized images may be configured to output the object-visualized images such that the object-visualized images are overlaid on the background-visualized image.

Calculating the effect of the interaction may be configured to calculate the effect of the interaction using one or more of types of the view-dependent interactive objects, effects assigned to the view-dependent interactive objects, states of the background objects, and a location of a collision with each bounding volume.

The viewpoints may be determined depending on locations and directions of pupils, heads, faces or eyes corresponding to the users.

Generating the background-visualized image and the object-visualized images is configured to, when the object-visualized images are generated, perform stereoscopic rendering using a binocular disparity.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an apparatus for providing interactive content according to an embodiment of the present invention;

FIG. 2 is an operation flowchart illustrating a method for providing interactive content according to an embodiment of the present invention;

FIG. 3 is a diagram illustrating an example in which a background-visualized image is displayed according to an embodiment of the present invention;

FIG. 4 is a diagram illustrating an example in which a background-visualized image and object-visualized images are displayed according to an embodiment of the present invention;

FIG. 5 is a diagram illustrating examples of bounding volumes corresponding to background objects according to an embodiment of the present invention;

FIG. 6 is a diagram illustrating examples of a change in the size of a view-dependent interactive object according to an embodiment of the present invention;

FIG. 7 is an operation flowchart illustrating an example of the step of rendering the view-independent background illustrated in FIG. 2; and

FIG. 8 is an embodiment of the present invention implemented in a computer system.

### DESCRIPTION OF THE PREFERRED EMBODIMENTS

The present invention may be variously changed, and may have various embodiments, and specific embodiments will be described in detail below with reference to the attached drawings. The advantages and features of the present invention and methods for achieving them will be more clearly understood from the following detailed description taken in conjunction with the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

However, the present invention is not limited to the following embodiments, and some or all of the following embodiments can be selectively combined and configured, and thus various modifications are possible. In the following embodiments, terms such as “first” and “second” are not intended to restrict the meanings of components, and are merely intended to distinguish one component from other components. A singular expression includes a plural expression unless a description to the contrary is specifically pointed out in context. In the present specification, it should be understood that terms such as “include” or “have” are merely intended to indicate that features or components described in the present specification are present, and are not intended to exclude the possibility that one or more other features or components will be present or added.

Embodiments of the present invention will be described in detail with reference to the accompanying drawings. In the following description of the present invention, the same reference numerals are used to designate the same or similar elements throughout the drawings, and repeated descriptions of the same components will be omitted.

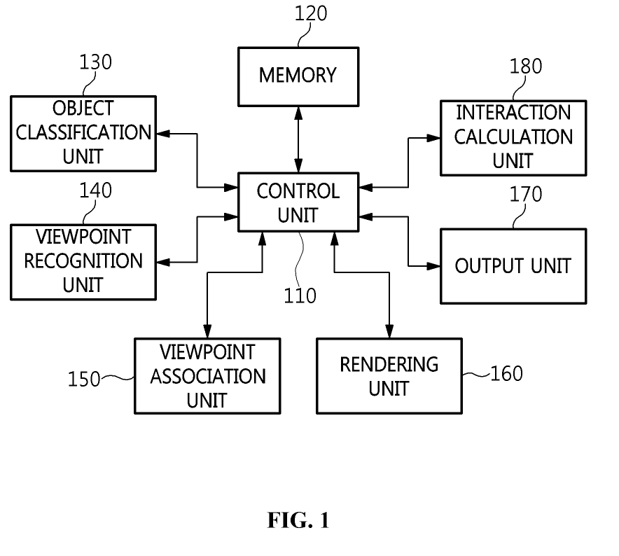

FIG. 1 is a block diagram illustrating an apparatus for providing interactive content (hereinafter also referred to as an “interactive content provision apparatus”) according to an embodiment of the present invention.

Referring to FIG. 1, the interactive content provision apparatus according to the embodiment of the present invention includes a control unit 110, memory 120, an object classification unit 130, a viewpoint recognition unit 140, a viewpoint association unit 150, a rendering unit 160, and an output unit 170.

The interactive content provision apparatus according to the embodiment of the present invention may further include an interaction calculation unit 180.

In detail, the control unit 110 is a kind of Central Processing Unit (CPU), which controls the overall process of the interactive content provision apparatus. That is, the control unit 110 may provide various functions by controlling the object classification unit 130, the viewpoint recognition unit 140, the viewpoint association unit 150, the rendering unit 160, the output unit 170, and the interaction calculation unit 180.

Here, the control unit 110 may include all types of devices capable of processing data, such as a processor. Here, the term “processor” may refer to a data-processing device that has a circuit physically structured to perform functions represented by code or instructions included in a program and that is embedded in hardware. In this way, examples of the data-processing device embedded in hardware may include, but are not limited to, processing devices such as a microprocessor, a CPU, a processor core, a multiprocessor, an Application-Specific Integrated Circuit (ASIC), and a Field-Programmable Gate Array (FPGA).

The memory unit 120 functions to temporarily or permanently store data processed by the control unit 110. Here, the memory unit 120 may include, but is not limited to, magnetic storage media or flash storage media.

The object classification unit 130 classifies content to be output into a view-independent background and view-dependent objects.

Here, the content to be output may include an interactive image that is capable of interacting with a user.

This is intended to classify elements of an interactive image into two types depending on the features thereof so that a specific object may be visualized based on the viewpoint of the corresponding user while allowing multiple users to simultaneously view the interactive image. The first type is a view-independent background, which is classified as a background element unrelated to the viewpoint of the user, and the second type is a view-dependent object, which is classified as a user object element related to the viewpoint of the user.

Here, when elements are classified as background elements, all objects rendered without regard to of the viewpoint of the user in spite of foreground or moving objects may be included in the background elements, rather than only a simply static background being included in the background elements.

Here, as the method for classifying a view-independent background and view-dependent objects, there may be used a method in which, when the viewpoint of the user has changed (e.g. a change in an experience location occurring due to the movement of the user), the extent of interruption indicating how distortion attributable to the change in viewpoint interrupts the overall immersive experience is measured, and objects are classified depending on the extent of interruption.

For example, an object present at a location very close to the user, an object represented in association with a specific body part of the user, and a geometric object, the distortion of which is easily identifiable, such as a straight line or a circle, may be classified as view-dependent objects closely related to the viewpoint of the user. In the present invention, objects rendered on the screen in relation to the viewpoint of the user in this way are referred to as “view-dependent objects”.

Unlike such view-dependent objects, a background independent of the viewpoint of the user is referred to as a “view-independent background”.

The viewpoint recognition unit 140 recognizes the viewpoints of users so as to render view-dependent objects based on the viewpoints of respective users.

Here, the viewpoint of each user may be determined depending on the three-dimensional (3D) location of the pupil of the user and the direction in which the pupil faces. Here, it is most preferable to recognize the user's pupil and utilize the recognized pupil as the viewpoint, but it is also possible to exploit approximate values using equipment that is more easily accessible from the standpoint of cost and efficiency. That is, the viewpoint of the user may be determined by using equipment capable of finding the location and direction of the user's head, face or eye and by approximating estimated values for the relative location and the direction of the pupil based on the equipment.

The viewpoint association unit 150 determines the viewpoints of users to be interactively associated with view-dependent objects.

That is, since view-dependent objects are rendered depending on separate viewpoints of respective users who participate in an experience, it is required to track the viewpoints of the users, determine a user whose viewpoint is to be used as a reference when each view-dependent object is rendered, and manage the viewpoint of the user corresponding to the reference in advance.

In particular, a view-dependent interactive object, generated for interaction from each user, may be interactively associated with the viewpoint of the corresponding user.

The rendering unit 160 generates a background-visualized image by rendering the view-independent background with respect to a hot spot corresponding to the viewpoint at a preset specific location and generates object-visualized images by rendering the view-dependent objects based on the viewpoints of respective users interactively associated therewith.

For example, when the present invention is practiced in a theater, a seat at the center of a plurality of front/rear and left/right seat arrays may be set as a hot spot to determine a representative viewpoint.

Here, the view-independent background is rendered with respect to the hot spot. Accordingly, as the location of a user moves farther away from the hot spot, the degree of distortion of the screen, which affects the experience, becomes greater, but such a degree is merely a slight distortion felt when an image is viewed at the border of a theater, and thus the user can sufficiently tolerate such distortion.

In a selective embodiment, the rendering unit 160 may generate object-visualized images by calculating the sizes and locations of the view-dependent objects using the locations and directions of the viewpoints of the users interactively associated with the view-dependent objects and by rendering the view-dependent objects.

In this case, the view-dependent objects may be rendered after distortion of the view-dependent objects has been corrected based on the viewpoints of the users.

Here, since the depths of the background objects may be detected based on depth information in a depth map corresponding to the view-independent background, the rendering unit 160 may determine an overlapping portion between the background objects such that a background object having a small depth in the depth map is viewed as being disposed in front of a background object having a large depth in the depth map.

In a selective embodiment, the rendering unit 160 may render view-dependent interactive objects for interacting with background objects included in the view-independent background, among the view-dependent objects, such that the view-dependent interactive objects include various changes, such as location changes, rotation, and animation switching of the view-dependent interactive objects depending on the input of the associated user (e.g. the use of various devices, such as gesture recognition and spatial recognition input devices, as well as normal input devices, such as a keyboard, a mouse or a joystick).

In a selective embodiment, respective background objects may use bounding volumes corresponding to collision ranges so as to determine whether interaction has occurred. Here, the bounding volumes may be located on the surface of the screen on which the corresponding objects are displayed.

Here, the bounding volumes may be represented by various primitives depending on the purpose and performance, such as virtual volumes, boxes, spheres, and meshes corresponding to the collision ranges.

In a selective embodiment, the sizes of respective bounding volumes may be determined using depth information in the depth map. That is, the sizes of respective bounding volumes may be determined in accordance with the sizes of the corresponding background objects. That is, the larger the depth of a background object in the depth map, the smaller the size of the bounding volume corresponding thereto, and the smaller the depth of a background object in the depth map, the larger the size of the bounding volume corresponding thereto.

In a selective embodiment, the rendering unit 160 may determine, based on the calculation by the interaction calculation unit 180, that interaction has occurred when a collision with the bounding volume of a specific background object is detected, and may generate a background visualized image by rendering background objects in which the effect of the interaction, calculated by the interaction calculation unit 180, is reflected.

For example, it is assumed that there is interactive content allowing the user to stretch his or her hand, shoot lightning, hit a spacecraft image in a background with the lightning, and cause the same to crash down. Here, the lightning is a view-dependent interactive object for interaction, among view-dependent objects, and the spacecraft is a background object included in a view-independent background. When the lightning reaches the bounding volume corresponding to the spacecraft, the interaction calculation unit 180 may determine that a collision has occurred, and may assign the effect of the spacecraft crashing down as the effect of the collision. The rendering unit 160 may render a scene in which the spacecraft is crashing down.

In a selective embodiment, when an animation effect depending on the traveling or movement of a view-dependent interactive object is represented, the rendering unit 160 may determine a change in the size of the view-dependent interactive object depending on the depth of a background object in the depth map corresponding to the traveling direction of the view-dependent interactive object. In this way, when the corresponding view-dependent interactive object has reached a target background object, the size of the view-dependent interactive object becomes the size thereof at the depth to which the corresponding background object belongs, and the creation of a natural collision scene is possible when a collision with the background object occurs. The reason for this is to improve the degree of immersion by reflecting sizes depending on depths in consideration of perspective because the displayed screen shows a 3D graphic image actually including depth information in two dimensions (2D).

For example, as a view-dependent interactive object becomes closer to a background object while traveling, the size of the view-dependent interactive object becomes smaller in proportion to the depth of the background object in a depth map to which the background object belongs in the corresponding animation direction. When the depth of the background object is large (i.e. deep) in the depth map in the direction in which the view-dependent interactive object travels, the size of the view-dependent interactive object becomes smaller at high speed. Conversely, when the depth of the background object is small (i.e. shallow) in the depth map in the direction in which the view-dependent interactive object travels, the size of the view-dependent interactive object becomes smaller at low speed.

In a selective embodiment, in the case of content for which a sense of immersion in a stereoscopic representation of view-dependent objects for respective users is important, the rendering unit 160 may generate object-visualized images by applying stereoscopic rendering based on binocular disparities to the view-dependent objects.

Here, the generated object-visualized images may be represented via a screen using a display panel, or may also be represented via a screen using a projector.

When the images are represented using the projector, this technology is also referred to as “projection-mapping technology”. The surface of the screen is obtained when 3D mesh data indicated by real-world coordinates, intrinsic parameters (e.g. a focal length, a center point, a size, etc.) of the projector and real-world 3D conversion values (location and rotation) of the screen are detected through projector calibration, and rendering is performed by regarding the real-world viewpoint of each user as a camera in a 3D graphics environment based on the detected intrinsic parameters and conversion values, and thus object-visualized images may be generated.

Here, the object-visualized images may be generated by rendering the view-dependent objects based on real-time 3D graphics using the locations and directions of the viewpoints of users.

In this case, the background objects included in the view-independent background may be displayed on the surface of the screen, but it may be considered that objects actually located at a certain place behind the surface of the screen are rendered through a 3D graphics camera and are then represented in 2D. Therefore, hiding of background objects and the sizes of the background objects may be determined using the depth map corresponding to the view-independent background.

The output unit 170 outputs the generated background-visualized image and the generated object-visualized images.

Here, the background-visualized image and the object-visualized images may be displayed on the screen using a display panel, or may be displayed on the screen using a projector.

In a selective embodiment, the output unit 170 may display each object-visualized image to be overlaid on each background-visualized image. This is because there are many cases where background objects included in the background-visualized image are located farther than view-dependent objects related to the viewpoints of the users, and thus it is not greatly unnatural that the view-dependent objects are rendered so as to be overlaid in front of the background objects.

However, a specific view-dependent object may be represented such that it is located behind a specific background object or such that a part of the specific view-dependent object is located behind the specific background object. In this case, it may be determined whether a view-dependent object is located in front or behind a background object using the depth map.

In this case, when a cylindrical, domed or atypical screen other than a planar screen is used as a screen, an image rendered as a plane is represented as if wallpapering were conducted. Taking representation in 3D graphics as an example, this image representation method is a scheme in which, when an image is regarded as a single texture and the screen is regarded as a mesh, the ratio of the size of each mesh polygon to the total area of the mesh and the relative location of each mesh polygon are represented by texture coordinates. In this way, an effect similar to sticking the image to the surface of the screen may be realized when viewed as a whole.

When a view-dependent object is represented as being overlaid on a background image in this way, object-visualized images related to the corresponding user are viewed normally when viewed from the viewpoint of the user, but object-visualized images of other users are viewed as distorted. However, since, due to the characteristics of interactive content, the background and objects of interest of the corresponding user (view-dependent objects rendered from the user's viewpoint) are represented without unnaturalness, the user may experience interactive content without decreasing a sense of immersion. Further, although distortion occurs in object-visualized images of other users, it may be understood how view-dependent objects are interacting with each individual user even in consideration of distortion to some degree unless the view-dependent objects are excessively close to the corresponding user.

The interaction calculation unit 180 may calculate whether view-dependent interactive objects are interacting with background objects, and may also calculate an effect appearing when interaction has occurred.

Here, whether a certain view-dependent interactive object travels and collides with the bounding volume corresponding to a specific background object may be calculated, and then whether interaction therebetween has occurred may be calculated.

Here, the effect of interaction may be calculated in consideration of the type of the view-dependent interactive object, the effect assigned thereto, the point of occurrence of the collision with the background object, etc.

For example, it is assumed that there is interactive content allowing the user to stretch his or her hand, shoot lightning, hit a spacecraft image, present in a background, with the lightning, and cause the same to crash down. Here, the lightning is a view-dependent interactive object for interaction, among view-dependent objects, and the spacecraft is a background object included in the view-independent background. It may be determined whether the spacecraft has been hit by the lightning only when it is checked whether there is a collision between the lightning and the spacecraft. The determination of the occurrence of a collision may be performed by checking whether the lightning has reached the bounding volume corresponding to the spacecraft. If the lightning is found to have reached the bounding volume corresponding to the spacecraft, it may be determined that a collision has occurred, and the effect of the spacecraft crashing down may be assigned as the effect of the collision.

Accordingly, when interactive content in which multiple users participate is provided, view-dependent objects for which users' individual senses of immersion are important and a view-independent background for which users' individual senses of immersion are not necessary are distinguished and separately visualized, thus allowing the multiple users to feel a high sense of immersion and greater realism.

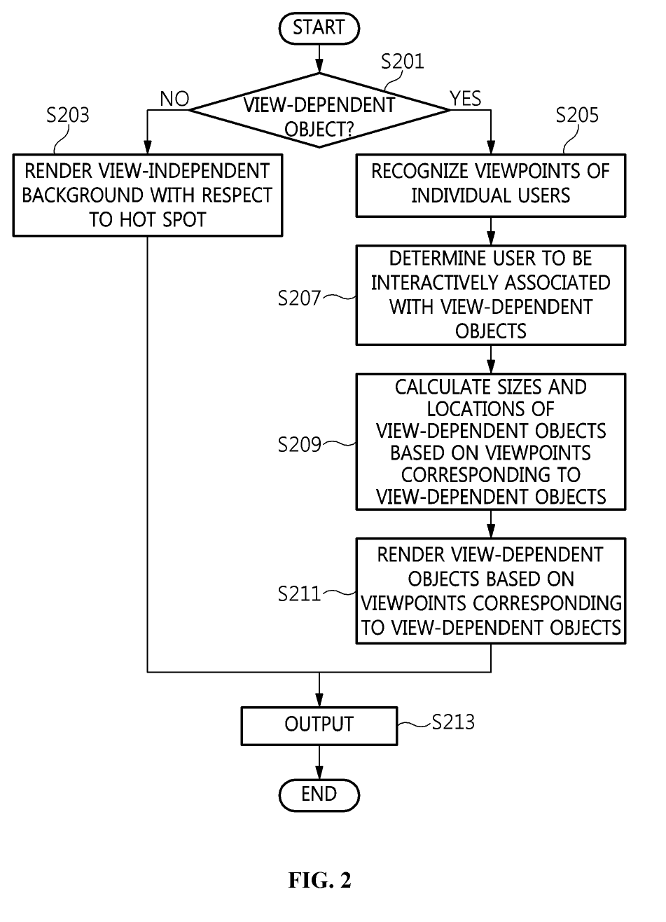

FIG. 2 is an operation flowchart illustrating a method for providing interactive content (hereinafter also referred to as an “interactive content provision method”) according to an embodiment of the present invention.

Referring to FIG. 2, in the interactive content provision method according to the embodiment of the present invention, the interactive content provision apparatus classifies content to be output into a view-independent background and view-dependent objects at step S201.

Here, the content to be output may include an interactive image that is capable of interacting with a user.

This is intended to classify elements of an interactive image into two types depending on the features thereof so that a specific object may be visualized based on the viewpoint of the corresponding user while allowing multiple users to simultaneously view the interactive image. The first type is a view-independent background, which is classified as a background element unrelated to the viewpoint of the user, and the second type is a view-dependent object, which is classified as a user object element related to the viewpoint of the user.

Here, when elements are classified as background elements, all objects rendered without regard to of the viewpoint of the user in spite of foreground or moving objects may be included in the background elements, rather than only a simply static background being included in the background elements.

Here, as the method for classifying a view-independent background and view-dependent objects, there may be used a method in which, when the viewpoint of the user has changed (e.g. a change in an experience location occurring due to the movement of the user), the extent of interruption indicating how distortion attributable to the change in viewpoint interrupts the overall immersive experience is measured, and objects are classified depending on the extent of interruption.

For example, an object present at a location very close to the user, an object represented in association with a specific body part of the user, and a geometric object, the distortion of which is easily identifiable, such as a straight line or a circle, may be classified as view-dependent objects closely related to the viewpoint of the user.

A background-visualized image is generated by rendering an object, classified as the view-independent background at step S201, with respect to a hot spot corresponding to the viewpoint at a preset specific location at step S203.

That is, the view-independent background must be displayed on the screen without regard to the viewpoints of multiple users even when the users simultaneously view an image on the same screen. Therefore, images corresponding to background elements are displayed regardless a change in the viewpoint of each user, even if the viewpoint (location, direction, etc.) of the user is changed. The background that is independent of the viewpoint in this way is described as a view-independent background, and is rendered such that it is viewed most easily in the hot spot corresponding to the viewpoint at the preset specific location.

For example, when the present invention is practiced in a theater, a seat at the center of a plurality of front/rear and left/right seat arrays may be set as a hot spot to determine a representative viewpoint.

Here, the view-independent background is rendered with respect to the hot spot. Accordingly, as the location of a user moves farther away from the hot spot, the degree of distortion of the screen, which affects the experience, becomes greater, but this degree is merely a slight distortion felt when an image is viewed at the border of a theater, and thus the user can sufficiently tolerate such distortion.

In this case, the background objects included in the view-independent background may be displayed on the surface of the screen, but it may be considered that objects actually located at a certain place behind the surface of the screen are rendered through a 3D graphics camera and are then represented in 2D. Therefore, overlapping between and hiding of background objects and the sizes of the background objects may be determined using the depth map corresponding to the view-independent background.

Here, the larger the depths of background objects in the depth map corresponding to the view-independent background, the smaller the sizes of the corresponding background objects compared to those of background objects having smaller depths in the depth map.

Respective background objects may use bounding volumes corresponding to collision ranges so as to determine whether interaction has occurred. Here, the bounding volumes may be located on the surface of the screen on which the corresponding objects are displayed.

The bounding volumes may be represented by various primitives depending on the purpose and performance, such as virtual volumes, boxes, spheres, and meshes corresponding to the collision ranges.

Here, the size of each bounding volume may be determined using depth information in the depth map. That is, the larger the depth of the background object in the depth map, the smaller the size of the bounding volume corresponding to the background object. The smaller the depth of the background object in the depth map, the larger the size of the bounding volume corresponding to the background object compared to that of the background object having a larger depth in the depth map.

In this case, when a collision with the bounding volume corresponding to a specific background object is detected, it may be determined that interaction has occurred, and a background-visualized image may be generated by rendering background objects in which the effect of this interaction is reflected.

For example, it is assumed that there is interactive content allowing the user to stretch his or her hand, shoot lightning, hit a spacecraft image, present in a background, with the lightning, and cause the same to crash down. Here, the lightning is a view-dependent interactive object for interaction, among view-dependent objects, and the spacecraft is a background object included in the view-independent background. It may be determined whether the spacecraft has been hit by the lightning only when it is checked whether there is a collision between the lightning and the spacecraft. The determination of the occurrence of a collision may be performed by checking whether the lightning has reached the bounding volume corresponding to the spacecraft. If the lightning is found to have reached the bounding volume corresponding to the spacecraft, it may be determined that a collision has occurred, and the effect of the spacecraft crashing down may be assigned as the effect of the collision.

For objects classified as view-dependent objects as step S201, the viewpoints of individual users are recognized at step S205, and the viewpoint of the user to be interactively associated with the view-dependent objects is determined at step S207.

That is, since view-dependent objects are rendered depending on separate viewpoints of respective users who participate in an experience, it is required to track the viewpoints of the users, determine a user whose viewpoint is to be used as a reference when each view-dependent object is rendered, and manage the viewpoint of the user corresponding to the reference in advance.

Here, the viewpoint of each user may be determined depending on the three-dimensional (3D) location of the pupil of the user and the direction in which the pupil faces. Here, it is most preferable to recognize the user's pupil and utilize the recognized pupil as the viewpoint, but it is also possible to exploit approximate values using equipment that is more easily accessible from the standpoint of cost and efficiency. That is, the viewpoint of the user may be determined by using equipment capable of finding the location and direction of the user's head, face or eye and by approximating estimated values for the relative location and the direction of the pupil based on the equipment.

Next, in the interactive content provision method according to the embodiment of the present invention, the interactive content provision apparatus calculates the sizes and locations of the view-dependent objects using the locations and directions of the viewpoints of the associated users at step S209.

Then, in the interactive content provision method according to the embodiment of the present invention, the interactive content provision apparatus generates object-visualized images by rendering the view-dependent objects using the locations and directions of the viewpoints of the associated users at step S211.

Here, the view-dependent objects may be rendered after the distortion thereof has been corrected based on the viewpoints of the users.

In this case, the object-visualized images may be generated by rendering view-dependent objects in real-time 3D graphics using the locations and directions of the viewpoints of the users.

Among the view-dependent objects, view-dependent interactive objects for interacting with background objects may be rendered such that the view-dependent interactive objects include various changes, such as location changes, rotation, and animation switching of the view-dependent interactive objects depending on the input of the associated user (e.g. the use of various devices, such as gesture recognition and spatial recognition input devices, as well as normal input devices, such as a keyboard, a mouse or a joystick).

In this case, when an animation effect depending on the traveling or movement of a view-dependent interactive object is represented, a change in the size of the view-dependent interactive object may be determined depending on the depth of a background object in the depth map corresponding to the traveling direction of the view-dependent interactive object. In this way, when the corresponding view-dependent interactive object has reached a target background object, the size of the view-dependent interactive object becomes the size thereof at the depth to which the corresponding background object belongs, and the creation of a natural collision scene is possible when a collision with the background object occurs. The reason for this is to improve the degree of immersion by reflecting sizes depending on depths in consideration of perspective because the displayed screen shows a 3D graphic image actually including depth information in two dimensions (2D).

For instance, as a view-dependent interactive object becomes closer to a background object while traveling, the size of the view-dependent interactive object becomes smaller in proportion to the depth of the background object in a depth map to which the background object belongs in the corresponding animation direction. When the depth of the background object is large (i.e. deep) in the depth map in the direction in which the view-dependent interactive object travels, the size of the view-dependent interactive object becomes smaller at high speed. Conversely, when the depth of the background object is small (i.e. shallow) in the depth map in the direction in which the view-dependent interactive object travels, the size of the view-dependent interactive object becomes smaller at low speed.

Here, in the case of content for which a sense of immersion in a stereoscopic representation of view-dependent objects for respective users is important, object-visualized images may be generated by applying stereoscopic rendering based on binocular disparities to the view-dependent objects.

The object-visualized images may be represented via a screen using a display panel, or may also be represented via a screen using a projector.

When the images are represented using the projector, this technology is also referred to as “projection-mapping technology”. The surface of the screen is obtained when 3D mesh data indicated by real-world coordinates, intrinsic parameters (e.g. a focal length, a center point, a size, etc.) of the projector and real-world 3D conversion values (location and rotation) of the screen are detected through projector calibration, and rendering is performed by regarding the real-world viewpoint of each user as a camera in a 3D graphics environment based on the detected intrinsic parameters and conversion values, and thus object-visualized images may be generated.

Next, in the interactive content provision method according to the embodiment of the present invention, the interactive content provision apparatus outputs the background-visualized image and the object-visualized images that have been generated through rendering at step S213.

Here, the background-visualized image and the object-visualized images may be displayed on the screen using a display panel, or may be displayed on the screen using a projector.

In this case, each object-visualized image may be represented as being overlaid on each background-visualized image. This is because there are many cases where background objects included in the background-visualized image are located farther than view-dependent objects related to the viewpoints of the users, and thus it is not greatly unnatural that the view-dependent objects are rendered so as to be overlaid in front of the background objects.

However, a specific view-dependent object may be represented such that it is located behind a specific background object or such that a part of the specific view-dependent object is located behind the specific background object. In this case, it may be determined whether a view-dependent object is located in front or behind a background object using the depth map.

In this case, when a cylindrical, domed or atypical screen other than a planar screen is used as a screen, an image rendered as a plane is represented as if wallpapering were conducted. Taking representation in 3D graphics as an example, this image representation method is a scheme in which, when an image is regarded as a single texture and the screen is regarded as a mesh, the ratio of the size of each mesh polygon to the total area of the mesh and the relative location of each mesh polygon are represented by texture coordinates. In this way, an effect similar to sticking the image to the surface of the screen may be realized when viewed as a whole.

When a view-dependent object is represented as being overlaid on a background image in this way, object-visualized images related to the corresponding user are viewed normally when viewed from the viewpoint of the user, but object-visualized images of other users are viewed as distorted. However, since, due to the characteristics of interactive content, the background and objects of interest of the corresponding user (view-dependent objects rendered from the user's viewpoint) are represented without unnaturalness, the user may experience interactive content without decreasing a sense of immersion. Further, although distortion occurs in object-visualized images of other users, it may be understood how view-dependent objects are interacting with each individual user even in consideration of distortion to some degree unless the view-dependent objects are excessively close to the corresponding user.

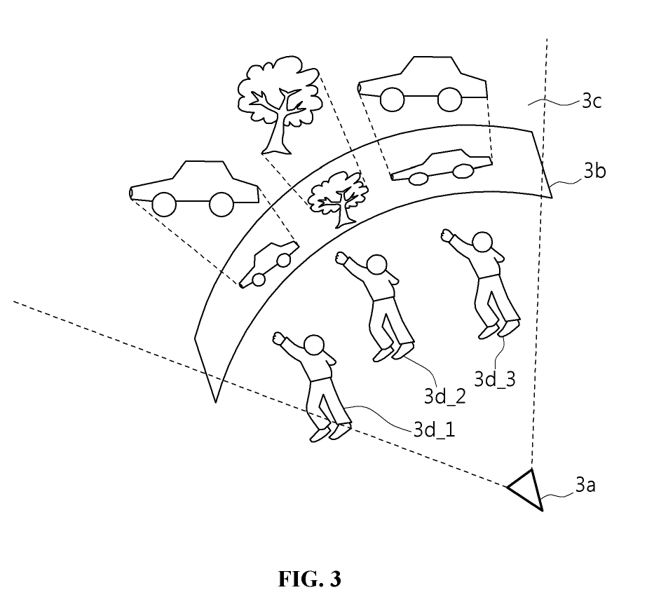

FIG. 3 is a diagram illustrating an example in which a background-visualized image is displayed according to an embodiment of the present invention.

Referring to FIG. 3, a background-visualized image is generated by rendering a view-independent background independent of the viewpoints of users with respect to a preset hot spot 3a, and is displayed on a screen 3b.

That is, although three users 3d_1, 3d_2, and 3d_3 are present in FIG. 3, the background-visualized image is generated independently from the views of the users 3d_1, 3d_2, and 3d_3.

Here, since the view-independent background is rendered with respect to the hot spot 3a, the degree of distortion on the screen for a content experience becomes greater as the locations of the users 3d_1, 3d_2, and 3d_3 are farther away from the hot spot, but the degree of distortion is merely a slight distortion that is experienced when the user views images at the border of a theater, so the user may tolerate such distortion.

Here, the virtual content space 3c in which background objects included in the view-independent background are located indicates the virtual space in which the relative locations of the background objects, including the relative depths of the background objects to the screen 3b, are to be represented. That is, in the virtual content space 3c, the background objects are depicted depending on the depth map corresponding to the view-independent background.

For example, when the depths of the background objects in the depth map are large in the virtual content space 3c, the background objects are rendered such that they are represented as being smaller than background objects having small depths on the screen 3b based on perspective.

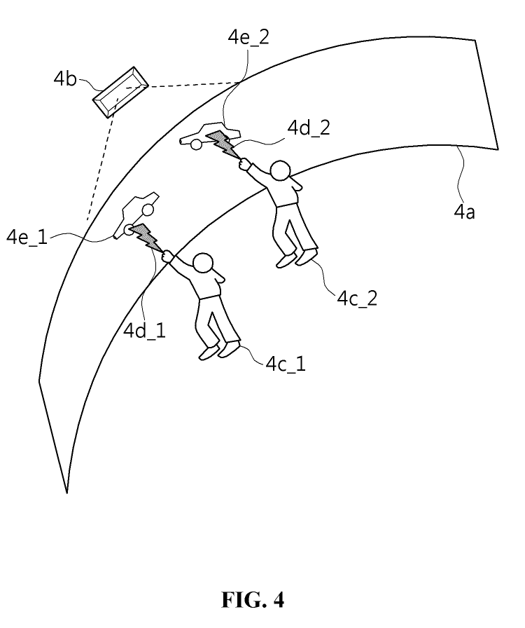

FIG. 4 is a diagram illustrating an example in which a background-visualized image and object-visualized images are displayed according to an embodiment of the present invention.

Referring to FIG. 4, a background-visualized image including two background objects 4e_1 and 4e_2 is displayed on a screen 4a. Further, object-visualized images corresponding to view-dependent interactive objects 4d_1 and 4d_2, generated for interaction with users 4c_1 and 4c_2, are also displayed on the screen 4a.

In this case, viewpoints corresponding to the users 4c_1 and 4c_2 may be tracked using a viewpoint-tracking sensor 4b.

Here, the viewpoint of each user may be determined depending on the 3D location of the pupil of the user and the direction in which the pupil faces. It is most preferable to recognize the pupil of the user and use the pupil as the viewpoint, but it is also possible to exploit approximate values using equipment that is more easily accessible from the standpoint of cost and efficiency. That is, the viewpoint of the user may be determined by using equipment capable of finding the location and direction of the user's head, face or eye and by approximating estimated values for the relative location and the direction of the pupil based on the equipment.

Here, the view-dependent interactive object 4d_1, generated for interaction with the user 4c_1, tracks the view of the user 4c_1 using the viewpoint-tracking sensor 4b and is rendered in association with the tracked view, and thus an object-visualized image is generated. Further, the view-dependent interactive object 4d_2, generated for interaction with the user 4c_2, tracks the view of the user 4c_2 using the viewpoint-tracking sensor 4b and is rendered in association with the tracked view, and thus an object-visualized image is generated.

Accordingly, respective users may be provided with images generated by rendering view-dependent interactive objects for interaction therewith in association with their viewpoints, thus enjoying interactive content having a high sense of immersion.

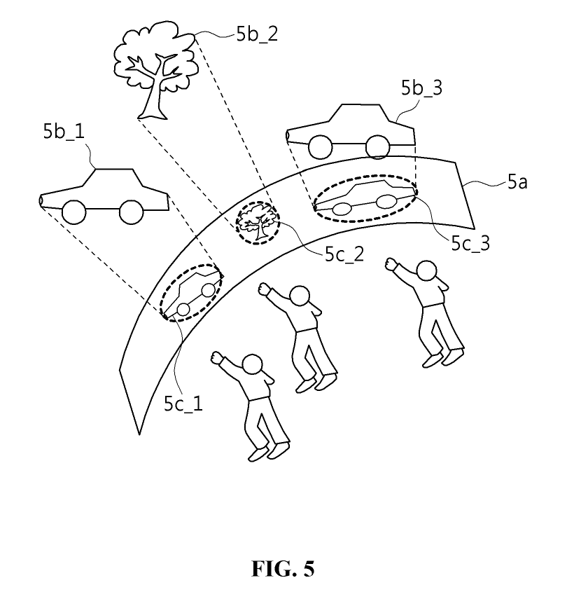

FIG. 5 is a diagram illustrating examples of bounding volumes corresponding to background objects according to an embodiment of the present invention.

Referring to FIG. 5, bounding volumes 5c_1, 5c_2, and 5c_3 corresponding to collision ranges may be used for respective background objects included in a view-independent background. Here, the bounding volumes 5c_1, 5c_2, and 5c_3 may be located on the surface of a screen 5a on which objects corresponding to the bounding volumes are displayed.

Here, the bounding volumes 5c_1, 5c_2, and 5c_3 may be represented by various primitives depending on the purpose and performance, such as virtual volumes, boxes, spheres, and meshes corresponding to the collision ranges.

Here, the sizes of respective bounding volumes 5c_1, 5c_2, and 5c_3 may be determined using depth information in a depth map. That is, the sizes of respective bounding volumes 5c_1, 5c_2, and 5c_3 may be determined in accordance with the sizes of the corresponding background objects 5b_1, 5b_2, and 5b_3. That is, the larger the depth of a background object in the depth map, the smaller the size of a bounding volume. The smaller the depth of the background object in the depth map, the larger the size of the bounding volume compared to that of a background object having a larger depth in the depth map.

Here, since the background object 5b_2 is located farther away from the screen than remaining background objects 5b_1 and 5b_3, the depth of the background object 5b_2 in the depth map is the largest. Since the background object 5b_3 is located closer to the screen than remaining background objects 5b_1 and 5b_2, the depth of the background object 5b_3 in the depth map is the smallest.

Therefore, the size of the bounding volume 5c_3 corresponding to the background object 5b_3 is reduced the least compared to the bounding volumes 5c_1 and 5c_2 corresponding to the remaining background objects 5b_1 and 5b_2. Further, the size of the bounding volume 5c_2 corresponding to the background object 5b_2 is reduced the most compared to the bounding volumes 5c_1 and 5c_3 corresponding to the remaining background objects 5b_1 and 5b_3.

In this case, when a collision with the bounding volume of a specific background object is detected, it may be determined that interaction has occurred, and a background-visualized image may be generated by rendering background objects in which the effect of the interaction is reflected.

Accordingly, even if interactive content is provided in 2D, the depths (distances) and locations of the background objects may be represented, and interactive content having a higher sense of immersion may be provided.

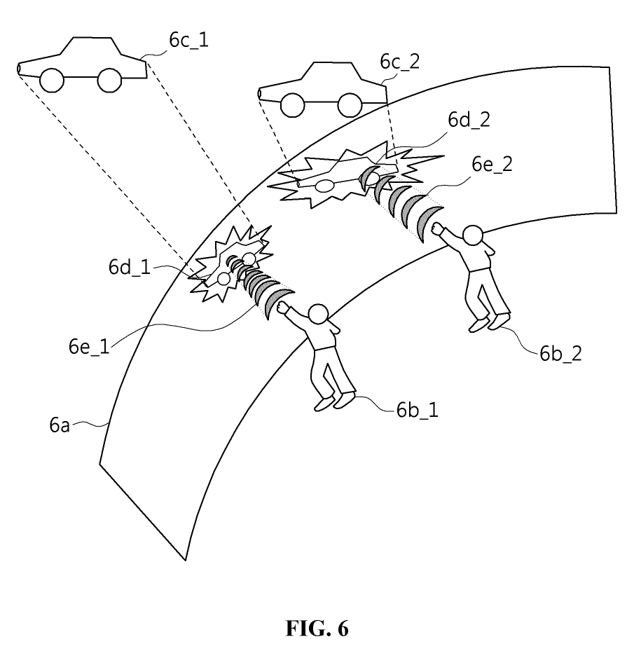

FIG. 6 is a diagram illustrating examples of a change in the size of a view-dependent interactive object according to an embodiment of the present invention.

Referring to FIG. 6, users 6b_1 and 6b_2 may generate view-dependent interactive objects 6e_1 and 6e_2 for interaction using various devices, such as gesture recognition and spatial recognition input devices, as well as normal input devices, such as a keyboard, a mouse or a joystick.

Here, since a background object 6d_1 has a depth larger than that of a remaining background object 6d_2 in a depth map, the background object 6d_1 is rendered smaller than the background object 6d_2 and is then displayed on a screen 6a. That is, the two background objects 6d_1 and 6d_2 correspond to objects 6c_1 and 6c_2 originally having similar sizes, but they are displayed on the screen 6a at different sizes from each other due to the difference between the depths thereof, thus further improving realism.

Here, when an animation effect attributable to the traveling or movement of the view-dependent interactive objects 6e_1 and 6e_2 is represented, changes in the sizes of the objects 6e_1 and 6e_2 may be determined depending on the depths of the background objects in the depth map corresponding to the directions in which the view-dependent interactive objects 6e_1 and 6e_2 are traveling. In this way, when the corresponding view-dependent interactive objects 6e_1 and 6e_2 finally reach the target background objects 6d_1 and 6d_2, the sizes of the view-dependent interactive objects 6e_1 and 6e_2 become sizes at the depths to which the background objects 6d_1 and 6d_2 belong. When the view-dependent interactive objects 6e_1 and 6e_2 collide with the background objects 6d_1 and 6d_2, the natural creation of collisions may occur. The reason for this is to improve the degree of immersion by reflecting the sizes of objects depending on the depths thereof in consideration of perspective because the image displayed on the screen 6a shows a 3D graphic image actually including depth information in 2D.

The view-dependent interactive object 6e_1 generated by the user 6b_1 is moving towards the background object 6d_1 having a depth larger than that of the background object 6d_2 in the depth map corresponding to the view-independent background. Therefore, it can be seen that, as the view-dependent interactive object 6e_1 is moved closer to the background object 6d_1, the view-dependent interactive object 6e_1 becomes smaller at higher speed than the view-dependent interactive object 6e_2.

Accordingly, based on the extents to which the sizes of the view-dependent interactive objects for interaction generated from the users are changed as the view-dependent interactive objects are traveling, the depths of the objects in the view-independent background are depicted, and thus interactive content having a higher sense of immersion and greater realism may be provided.

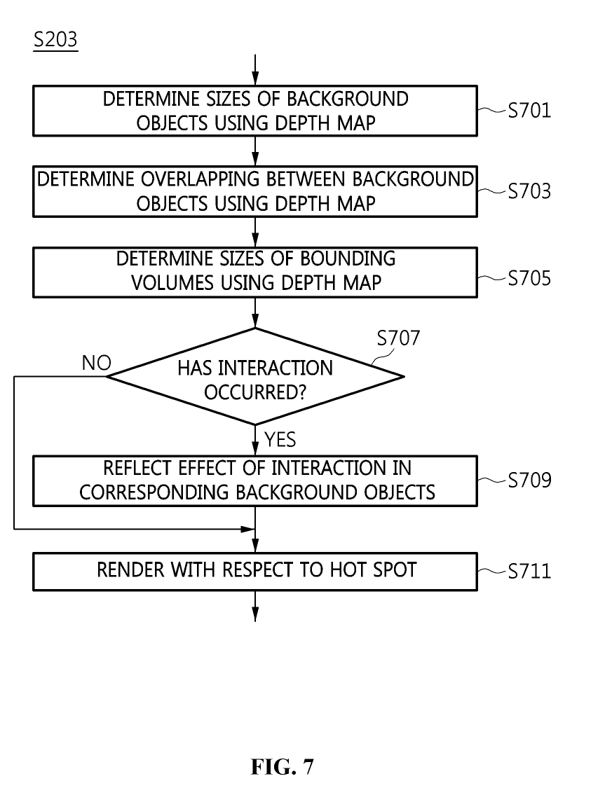

FIG. 7 is an operation flowchart illustrating an example of the step S203 of rendering the view-independent background illustrated in FIG. 2.

Referring to FIG. 7, the step S203 of rendering the view-independent background, illustrated in FIG. 2, determines the sizes of background objects included in the view-independent background using a depth map corresponding to the view-independent background at step S701.

Here, the larger the depths of the background objects in the depth map corresponding to the view-independent background, the smaller the sizes of the background objects compared to those of background objects having smaller depths in the depth map.

Further, the step S203 of rendering the view-independent background, illustrated in FIG. 2, may determine overlapping between the background objects included in the view-independent background using the depth map corresponding to the view-independent background at step S703.

Here, since the depths of the background objects may be detected based on the depth information in the depth map corresponding to the view-independent background, an overlapping portion between the background objects may be determined such that a background object having a small depth in the depth map is viewed as being disposed in front of a background object having a large depth in the depth map.

Further, the step S203 of rendering the view-independent background, illustrated in FIG. 2, may determine the sizes of bounding volumes corresponding to the background objects included in the view-independent background, using the depth map corresponding to the view-independent background at step S705.

Here, the larger the depth of the corresponding background object in the depth map, the smaller the size of the bounding volume corresponding to the background object. The smaller the depth of the background object in the depth map, the larger the size of the bounding volume corresponding to the background object compared to that of the background object having a larger depth in the depth map.

Furthermore, the step S203 of rendering the view-independent background, illustrated in FIG. 2, determines whether interaction of the background objects, included in the view-independent background, with view-dependent interactive objects has occurred at step S707.

If it is determined at step S707 that any interaction between the background objects included in the view-independent background and the view-dependent interactive objects has occurred, the effect of this interaction is reflected in the background objects with which the interaction has occurred at step S709, and the view-independent background is rendered with respect to a hot spot at step S711.

If it is determined at step S707 that there is no interaction between the background objects, included in the view-independent background, and the view-dependent interactive objects, the view-independent background is rendered with respect to the hot spot at step S711.

In a selective embodiment, among steps S701, S703, S705, S707, S709, and S711, the step S701 of determining the sizes of the background objects and the step S703 of determining overlapping between the background objects may be simultaneously performed.

In a selective embodiment, among steps S701, S703, S705, S707, S709, and S711, the step S703 of determining overlapping between the background objects may be performed first, and the step S701 of determining the sizes of the background objects may be subsequently performed.

In a selective embodiment, among steps S701, S703, S705, S707, S709, and S711, the step S703 of determining overlapping between the background objects and the step S705 of determining the sizes of the bounding volumes may be simultaneously performed.

In a selective embodiment, among steps S701, S703, S705, S707, S709, and S711, the step S705 of determining the sizes of the bounding volumes may be performed first, and the step S703 of determining overlapping between the background objects may be subsequently performed.

In a selective embodiment, among steps S701, S703, S705, S707, S709, and S711, the step S701 of determining the sizes of the background objects, the step S703 of determining overlapping between the background objects, and the step S705 of determining the sizes of the bounding volumes may be simultaneously performed.

Accordingly, even if interactive content is provided in 2D, the representation of the depths (distances) and locations of background objects is possible, and interactive content having a higher sense of immersion may be provided.

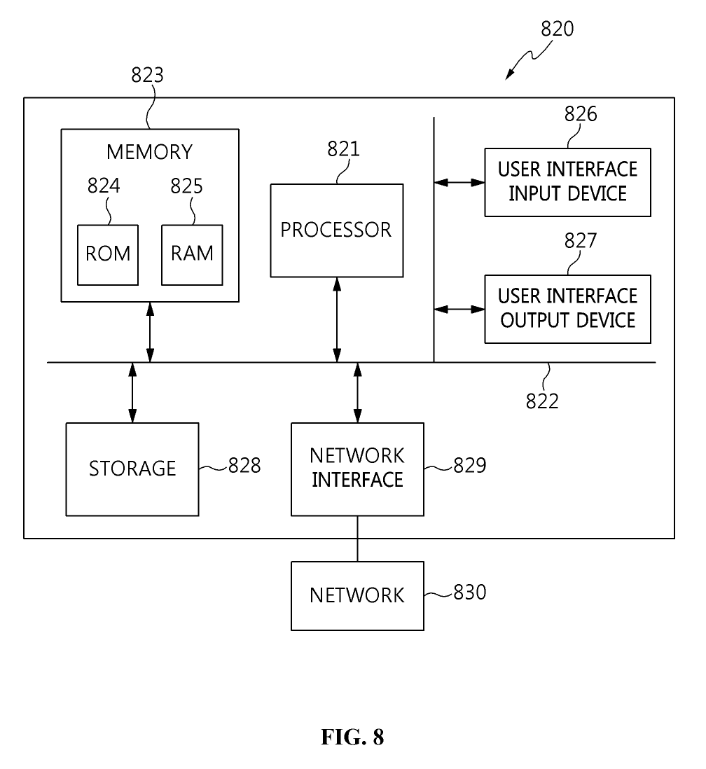

An embodiment of the present invention may be implemented in a computer system, e.g., as a computer readable medium. As shown in in FIG. 8, a computer system 820 may include one or more of a processor 821, a memory 823, a user interface input device 826, a user interface output device 827, and a storage 828, each of which communicates through a bus 822. The computer system 820 may also include a network interface 829 that is coupled to a network 830. The processor 821 may be a central processing unit (CPU) or a semiconductor device that executes processing instructions stored in the memory 823 and/or the storage 828. The memory 823 and the storage 828 may include various forms of volatile or non-volatile storage media. For example, the memory may include a read-only memory (ROM) 824 and a random access memory (RAM) 825.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

Specific executions, described in the present invention, are only embodiments, and are not intended to limit the scope of the present invention using any methods. For the simplification of the present specification, a description of conventional electronic components, control systems, software, and other functional aspects of systems may be omitted. Further, connections of lines between components shown in the drawings or connecting elements therefor illustratively show functional connections and/or physical or circuit connections. In actual devices, the connections may be represented by various replaceable or additional functional connections, physical connections or circuit connections. Further, unless a definite expression, such as “essential” or “importantly” is specifically used in context, the corresponding component may not be an essential component for the application of the present invention.

In accordance with the present invention, there can be provided an apparatus and method for providing interactive content, which represent individual experience elements of each of multiple users based on the viewpoint of the corresponding user while allowing the users to simultaneously view an image via a single screen, by separately visualizing a view-independent background and view-dependent objects, thus maximizing personal experience elements and improving a feeling of satisfaction in an experience in immersive multi-user interactive images through view-dependent interaction.

Further, there can be provided an apparatus and method for providing interactive content, which represent background objects included in a view-independent background and view-dependent interactive objects for interaction by adjusting the sizes of the background objects and the view-dependent interactive objects in consideration of depth information, thus providing a user's view-dependent interaction having greater realism.

Therefore, the spirit of the present invention should not be defined by the above-described embodiments, and it will be apparent that the accompanying claims and equivalents thereof are included in the scope of the spirit of the present invention.

What is claimed is:

1. An apparatus for providing interactive content, comprising:
an object classification unit for classifying content to be output into a view-independent background and view-dependent objects;
a viewpoint association unit for determining viewpoints of users who are to be interactively associated with respective view-dependent objects, and interactively associating the viewpoints of the users with the view-dependent objects;
a rendering unit for generating a background-visualized image by rendering the view-independent background with respect to a hot spot, and generating object-visualized images by rendering the view-dependent objects based on viewpoints interactively associated with respective view-dependent objects; and
an output unit for outputting the background-visualized image and the object-visualized images.

2. The apparatus of claim 1, further comprising an interaction calculation unit for calculating whether interaction between background objects, included in the view-independent background, and the view-dependent objects has occurred, and calculating an effect of the interaction using bounding volumes corresponding to collision ranges of the background objects,
wherein the rendering unit generates the background-visualized image and the object-visualized images by reflecting the effect of the interaction based on the calculation by the interaction calculation unit.

3. The apparatus of claim 2, wherein:
the rendering unit is configured to, when the background-visualized image is generated, determine hiding of the background objects and sizes of the background objects using a depth map corresponding to the view-independent background, and
the bounding volumes are determined in accordance with the sizes of the corresponding background objects.

4. The apparatus of claim 3, wherein the rendering unit is configured to, when the object-visualized image is generated, determine sizes and locations of the view-dependent objects in consideration of the view-independent background and traveling directions based on the viewpoints interactively associated with respective view-dependent objects.

5. The apparatus of claim 4, wherein the rendering unit is configured to determine changes in sizes of view-dependent interactive objects for interaction with the background objects depending on traveling of the view-dependent interactive objects in consideration of depths of the background objects in the depth map, corresponding to traveling directions of the view-dependent interactive objects.

6. The apparatus of claim 5, wherein the output unit is configured to output the object-visualized images such that the object-visualized images are overlaid on the background-visualized image.

7. The apparatus of claim 6, wherein the interaction calculation unit calculates the effect of the interaction using one or more of types of the view-dependent interactive objects, effects assigned to the view-dependent interactive objects, states of the background objects, and a location of a collision with each bounding volume.

8. The apparatus of claim 7, wherein the viewpoints are determined depending on locations and directions of pupils, heads, faces or eyes corresponding to the users.

9. The apparatus of claim 8, wherein the rendering unit is configured to, when the object-visualized images are generated, perform stereoscopic rendering using a binocular disparity.

10. A method for providing interactive content, comprising:
classifying content to be output into a view-independent background and view-dependent objects;
determining viewpoints of users who are to be interactively associated with respective view-dependent objects and interactively associating the viewpoints of the users with the view-dependent objects;
generating a background-visualized image by rendering the view-independent background with respect to a hot spot, and generating object-visualized images by rendering the view-dependent objects based on the viewpoints interactively associated with respective view-dependent objects; and
outputting the background-visualized image and the object-visualized images.

11. The method of claim 10, further comprising calculating whether interaction between background objects, included in the view-independent background, and the view-dependent objects has occurred, and calculating an effect of the interaction using bounding volumes corresponding to collision ranges of the background objects,
wherein generating the background-visualized image and the object-visualized images is configured to generate the background-visualized image and the object-visualized images by reflecting the effect of the interaction based on the calculation by the interaction calculation unit.

12. The method of claim 11, wherein:
generating the background-visualized image and the object-visualized images is configured to, when the background-visualized image is generated, determine hiding of the background objects and sizes of the background objects using a depth map corresponding to the view-independent background, and
the bounding volumes are determined in accordance with the sizes of the corresponding background objects.

13. The method of claim 12, wherein generating the background-visualized image and the object-visualized images is configured to, when the object-visualized image is generated, determine sizes and locations of the view-dependent objects in consideration of the view-independent background and traveling directions based on the viewpoints interactively associated with respective view-dependent objects.

14. The method of claim 13, wherein generating the background-visualized image and the object-visualized images is configured to determine changes in sizes of view-dependent interactive objects for interaction with the background objects depending on traveling of the view-dependent interactive objects in consideration of depths of the background objects in the depth map, corresponding to traveling directions of the view-dependent interactive objects.

15. The method of claim 14, wherein outputting the background-visualized image and the object-visualized images is configured to output the object-visualized images such that the object-visualized images are overlaid on the background-visualized image.

16. The method of claim 15, wherein calculating the effect of the interaction is configured to calculate the effect of the interaction using one or more of types of the view-dependent interactive objects, effects assigned to the view-dependent interactive objects, states of the background objects, and a location of a collision with each bounding volume.

17. The method of claim 16, wherein the viewpoints are determined depending on locations and directions of pupils, heads, faces or eyes corresponding to the users.

18. The method of claim 17, wherein generating the background-visualized image and the object-visualized images is configured to, when the object-visualized images are generated, perform stereoscopic rendering using a binocular disparity.
